(19) United States
(12) Patent Application Publication
(10) Pub. No.: US 2014/0009372 A1
(43) Pub. Date: Jan. 9, 2014

(54) FAILSAFE CONTENT PRESENTATION FOR ELECTRONIC SIGNAGE APPLICATIONS

(71) Applicant: Zone24x7 Inc., San Jose, CA (US)

(72) Inventors: Llavanya Fernando, San Jose, CA (US); Schayne Jallow, San Jose, CA (US); Sankalpa Gamwarige, Colombo (LK); Ushan Karunathilaka, Karadeniya (LK); Manjula Dissanayake, Pelewatte (LK)

(73) Assignee: Zone24x7 Inc., San Jose, CA (US)

(21) Appl. No.: 13/690,010

(22) Filed: Nov. 30, 2012

Related U.S. Application Data
(63) Continuation-in-part of application No. 13/541,970, filed on Jul. 5, 2012, now abandoned.

(51) Int. Cl. G09G 3/18

(52) U.S. Cl. CPC G09G 3/18
USPC 345/87

(57) ABSTRACT

The use of bi-stable display technology in electronic signage systems introduces non-volatile content. As a result, incorrect pricing may be displayed during times of system failure such as battery removal, electronic signage relocation, loss of network connectivity, battery exhaustion, etc. Such failures are detected, and the content is invalidated upon occurrence of a failure.

The present invention relates electronic signage.

### BACKGROUND OF THE INVENTION

Present day retail enterprises use electronic signage appliances to display prices, promotional data and advertisements. Most such signage appliances are battery operated portable and equipped with a bi-stable display technology which requires zero power to retain the display content. Content of the electronic signs gets updated automatically by wireless methodologies without intervention of the store associate. FIG. 1 illustrates an example of electronic signage appliances being deployed in a retail store. Electronic signs such as electronic sign 100 are connected via wireless connections such as wireless connection 102 and a wireless network to one or more content servers such as content server 101. Server infrastructure may also include a content depository, one or more back end servers or systems, etc.

According to the nature of the bi-stable display technology, the display content will remain as it is even if the power is removed. Accidental or deliberate removal of the battery may cause the content of particular electronic sign to be invalid. If the battery level is too low, there is a chance an electronic sign will not get the correct content from the content server for display. Also, an “orphaned” electronic sign (e.g., unable to communicate with the content server) cannot get the correct content from the content server. This may cause contents of the electronic sign to be invalid. In particular, if the display is moved to another place accidently or deliberately, the content of the sign will be incorrect.

The use of non-volatile images in electronic signage could result in incorrect pricing being displayed when certain failures occur and could result in negative consequences or penalties, such as lost sales when the displayed price is higher than it should be, lost margin when the displays price is lower than it should be, fines for being in violation of consumer pricing laws, etc.

### BRIEF DESCRIPTION OF THE DRAWING FIGURES

The present invention may be further understood from the following Detailed Description in conjunction with the appended drawing figures. In the drawing:

FIG. 1 is a diagram of an electronic signage appliance being deployed in a retail store.

FIG. 2A is a diagram of a mechanical switch configuration used to detect battery removal.

FIG. 2B is a diagram of the mechanical switch configuration of FIG. 2A upon opening of the battery cover.

FIG. 2C is a diagram of another mechanical switch configuration used to detect battery removal.

FIG. 2D is a diagram of the mechanical switch configuration of FIG. 2C upon opening of the battery cover.

FIG. 3 is a diagram showing various status indicators.

FIG. 4 is a flowchart of a battery level detection algorithm.

FIG. 5A is a diagram of an electronic sign having a motion detector in a first state.

FIG. 5B is a diagram of the electronic sign of FIG. 5A in a second state.

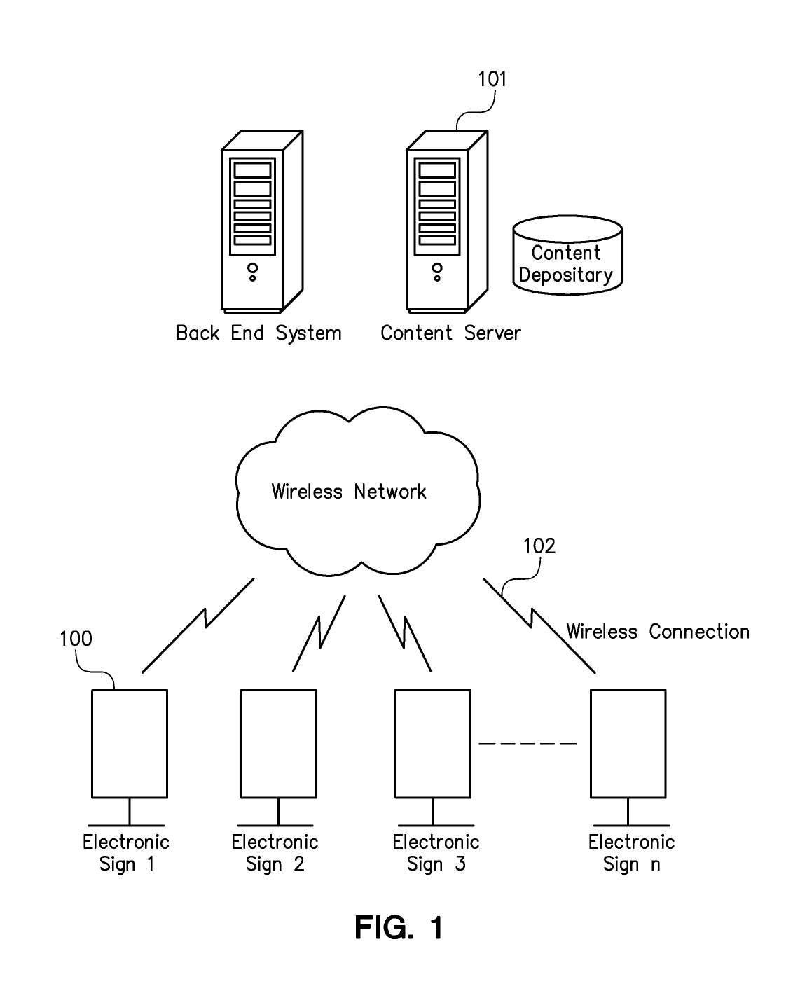

### DETAILED DESCRIPTION

### Summary

Failsafe methods are provided to guarantee that the content being displayed by electronic signage is valid. The ultra-low power typical of electronic signage appliances is sufficient to implement the failsafe methods in a system.

### Description

The use of bi-stable display technology in electronic signage systems introduces non-volatile content. As a result, incorrect pricing may be displayed during times of system failure such as battery removal, electronic signage relocation, loss of network connectivity, battery exhaustion, etc. Such failures are detected, and the content is invalidated upon occurrence of a failure.

Battery Removal Detection

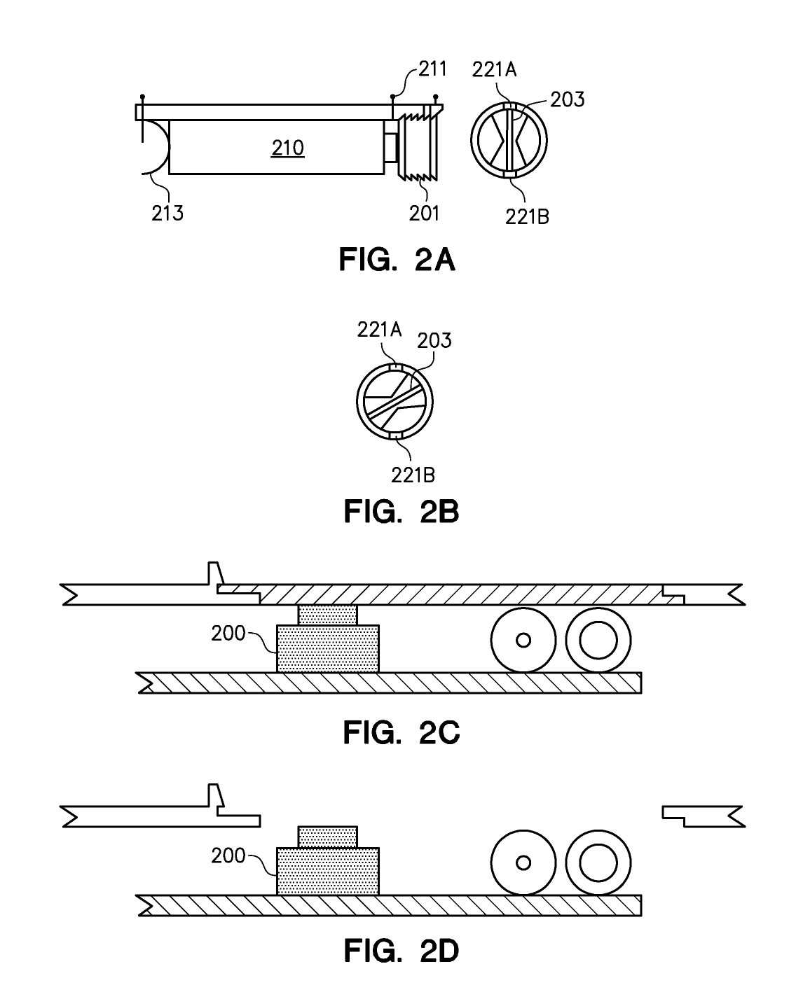

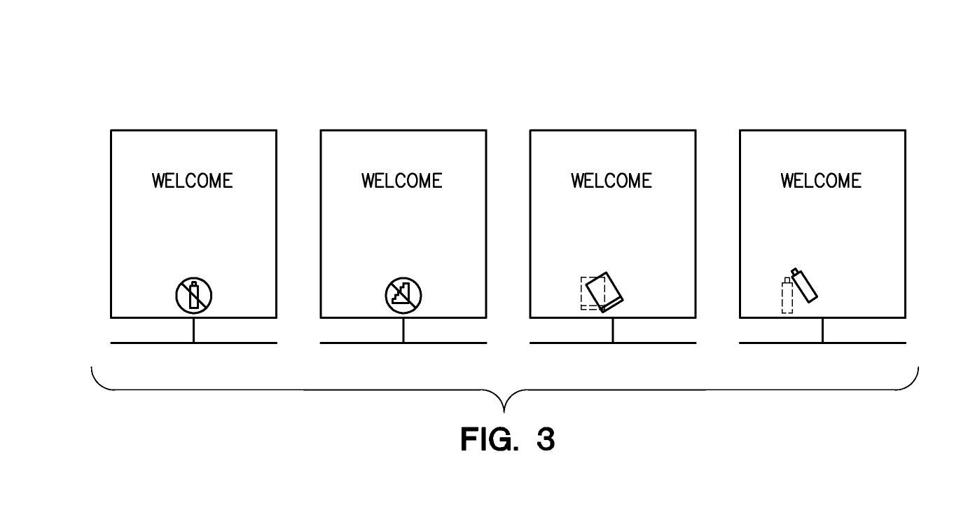

Referring to FIGS. 2A-2D, in one exemplary embodiment, a battery case of an electronic sign is equipped with a mechanical switch, and this switch is activated in the course of and prior to the battery is being removed from the electronic sign. In one embodiment, the battery cover is designed such a way as to take some time to remove completely, providing enough time to clear the display. The mechanical switch wakes up the electronic circuitry and internal firmware of the electronic sign, causing it to change the display. The display may be changed by, for example, erasing the content, or changing it to a default image.

In the example of FIG. 2A, a threaded battery cap 201 contacts a positive terminal 211 of a battery 210 and holds the battery against a spring-loaded battery terminal 213. A battery housing incorporates top and bottom conductors 221A, 221B for detecting battery removal. The battery cap 201 incorporates a conductor 203 that establishes electrical continuity between the conductors 221A, 221B when the battery cap 201 is in a closed position. Referring to FIG. 2B, in an opened position, continuity is disrupted. As a result, a battery removal detection terminal 205 is activated.

In the configuration of FIGS, 2C and 2D, a mechanical switch 200 is depressed when the battery cover is closed (FIG. 2C), and is released when the battery cover is opened (FIG. 2D).

When the display contents are changed as a result of battery removal or other condition, the changed display may optionally include a status indication that readily conveys to the store associate the reason for clearing the content. FIG, 3 illustrates possible status indicators (e.g., low battery, lack of connectivity, impermissible movement, battery removal) displayed as part of the display content of a bi-stable display, indicating the reason for putting the display into default mode or erasing the content,

Battery Level Detection

Most signage appliances are powered by non-rechargeable batteries, and no fuel gauge is incorporated to measure the battery usage. In one embodiment, once the battery is inserted into the electronic sign, firmware initializes a usage counter, possibly with the help of the back end system. Firmware increases the usage counter using experimentally-derived values. In addition, battery voltage is measured when the electronic sign is in the active mode. If the usage counter exceeds a pre-set threshold, or if battery voltage falls below a pre-set threshold, content will be erased or changed to a default image, optionally with a status indicator.

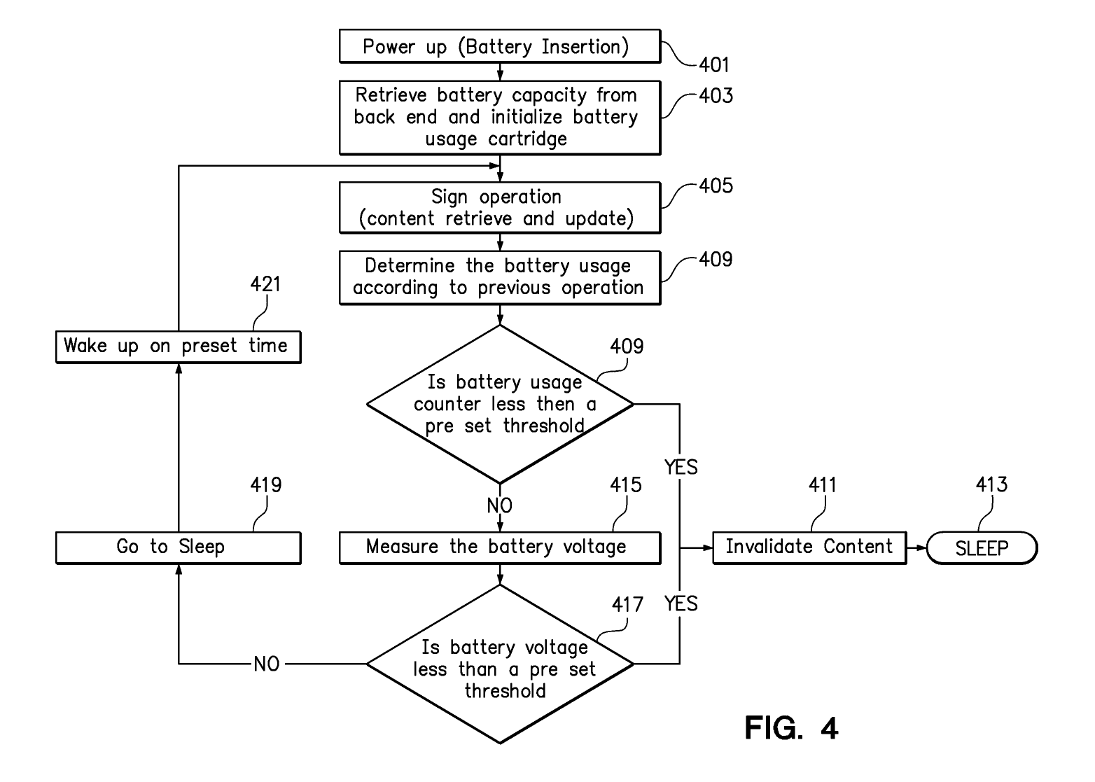

FIG. 4 illustrates a battery level detection algorithm in accordance with one embodiment. Prior to sign operation, battery insertion occurs (step 401), after which battery capacity is retrieved from the back-end system and used to initialize a battery usage counter (step 403). In step 405, sign operation begins, during which the sign retrieves and updates content. Depending on the operations performed, the battery usage counter is then decremented (step 407).

In step 409, a check is made to see whether or not the battery usage counter is less than a threshold. If so, then the content of the sign is invalidated (step 411), and sleep ensues (step 413). If not, then the battery voltage is measured (step 415), and a further check is made whether or not the battery voltage is less than a threshold (step 417). If so, then the content of the sign is invalidated (step 411), and sleep ensues (step 413).

If not, then the electronic sign enters sleep mode (step 419). It wakes from sleep mode after a time interval has elapsed (step 421), and sign operation continues as previously described.

Movement Detection

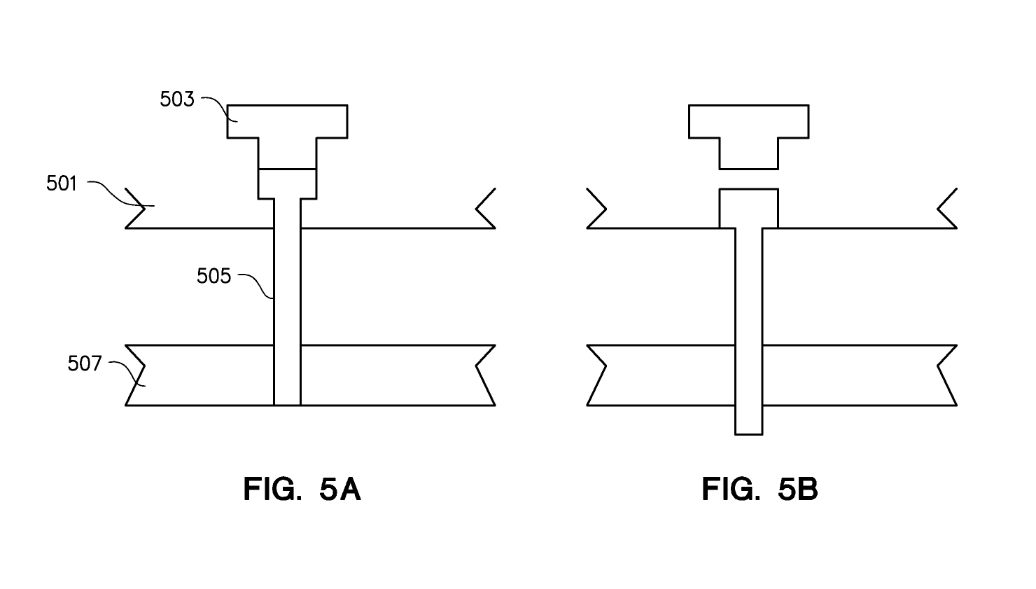

The electronic sign can be equipped with a motion sensor. FIG. 5A and 5B illustrate one possible motion sensor arrangement using a micro-switch. In FIG. 5A, a sign 501 is provided with a micro-switch 503, which functions as a motion switch, and a motion switch activator 505. The motion switch activator is coupled to a sign stand 507. When the sign 501 is placed on a table or other supporting surface, the motion switch 503 is closed. If the sign 501 is lifted, spring action of the motion switch activator 505 results in the motion switch 503 being opened such that motion is detected. The sign contents may then be invalidated accordingly.

Other examples of suitable motion sensors include ultra low power MEMs sensors, mercury-based sensors, moving-ball or micro-switch-based motion sensors, etc. Some motion sensors may be capable of motion pattern detection in order to filter out slight accidental movements. Alternatively, filtering may be accomplished in firmware. A motion sensor signal wakes up the electronic circuitry, whereupon firmware then erases the content or puts the content into a default mode with a status indicator.

Orphan Detection

In some instances, the electronic sign may lose connectivity, becoming “orphaned.” Firmware of the electronic signage appliance wakes up periodically in accordance with a pre-set period, checks for connectivity with the content server, and gets new content updates. If connectivity is unavailable or unsuccessful, the device is sent to an orphan state. In one embodiment, each content display has associated with it an expiry date. The electronic sign tries to establish connection with the content server before reaching the expiry date of the existing content, If the electronic sign is unable to establish connection with the content server and get the next update before the end of the expiration period, then at the expiration time, it will go to the orphan state and erase the content, or put the content into default mode with a status indicator.

Hardware Watchdog Timer

In some embodiments, a hardware based watchdog timer continuously monitors the firmware and issues a hardware reset when unresponsiveness is detected. The hardware reset clears the content being currently displayed on the display as the integrity of those contents cannot be guaranteed.

Self Diagnosis and Periodic State Monitoring

In some embodiments, firmware of the electronic sign may include a self diagnosis utility to detect hardware faults of the device. Upon detection of any hardware fault, display invalidation is performed and a failure message is conveyed to the back end system. Further interactive diagnosis capabilities may be included in the firmware to enable it to display a machine readable code such as QR code. In this instance, a store associate supposed scans the code using a handheld computer and transfers the code to the backend system, which verifies the received code. The code may contain the serial number of the electronic sign and a random number that has been transferred to the electronic sign previously, before running of the diagnosis program. The backend system verifies the random number part of the code received from the handheld device against the random number which was already passed to the electronic sign identified by the serial number part of the code. A verification result is transferred to the hand held computer and is also stored in a central database. The ability of the electronic display sign to correctly incorporate the random number as part of the machine readable code is an indication of proper functioning of the electronic display sign. Scanning of the machine readable code for purposes of identifying the electronic display sign may be performed routinely for various purposes, including for example associating an electronic display sign with particular merchandise. Combining the serial number of the electronic display sign and the random number in a single machine readable code enables health monitoring to be performed in the ordinary course of business.

It will be apparent to those of ordinary skill in the art that the present invention can be embodied in other specific forms without departing from the spirit or essential character thereof The foregoing description is therefore to be regarded as illustrative, not restrictive. The scope of the invention is defined by the appended claims, not the foregoing description, and all changes which some within the range of scope of equivalents thereof are intended to be embraced therein.

What is claimed is

1. A method of displaying content on an electronic sign, comprising:
detecting one of lost of power, loss of connectivity, and movement; and
in response to said detecting, changing display contents of the electronic sign to remove or invalidate offer information.

2. The method of claim 1, comprising displaying a status indication indicating a reason for changing the display contents.

3. The method of claim 1, comprising detecting battery removal.

4. The method of claim 1, comprising detecting movement of the electronic sign.

5. The method of claim 4, comprising filtering out non-critical movement.

6. The method of claim 1, comprising detecting a low battery condition.

7. The method of claim 1, comprising detecting loss of connectivity to one or more content servers.

8. The method of claim 1, wherein an expiration date or time is associated with the display contents, comprising changing display contents of the electronic sign upon expiration.

9. An electronic display sign comprising:
a bi-stable display;
a controller coupled to the display;
circuitry coupled to the controller for detecting one of lost of power, loss of connectivity, and movement;
wherein the controller is configured to, in response to said detecting, changing display content of the electronic sign to remove or invalidate offer information.

10. The apparatus of claim 9, wherein the controller is configured to display a status indication indicating a reason for changing the display contents.

11. The apparatus of claim 9, wherein said circuitry comprises circuitry for detecting battery removal.

12. The apparatus of claim 9, wherein said circuitry comprises circuitry for detecting movement of the electronic sign.

13. The apparatus of claim 12, wherein the circuitry for detecting movement is configured to filter out non-critical movement.

14. The apparatus of claim 12, wherein the controller is configured to filter out non-critical movement.

15. The apparatus of claim 9, wherein said circuitry comprises circuitry for detecting a low battery condition.

16. The apparatus of claim 9, wherein the controller is configured to detect loss of connectivity to one or more content servers.

17. The apparatus of claim 9, wherein an expiration date or time is associated with the display contents, and wherein the controller is configured to change display contents of the electronic sign upon expiration.

18. The apparatus of claim 9, comprising a hardware based watchdog timer for monitoring responsiveness of the firmware and issuing a hardware reset if an unresponsive condition is detected.

19. The apparatus of claim 18, wherein the hardware reset causes content of the electronic sign to be cleared or invalidated.

20. The apparatus of claim 9, wherein the electronic display sign is configured to display a machine readable code comprising a serial number of the electronic display sign and a random number for testing for proper operation of the electronic display sign.

21. The apparatus of claim 20, wherein the machine readable code is a 2D barcode.

22. The method of claim 1, further comprising:
the electronic display sign displaying a machine readable code comprising a serial number of the electronic display sign and a random number for testing for proper operation of the electronic display sign; and
a human is using a hand held computer to read the machine readable code and verify proper operation of the display using a single scan of the machine readable code.
